(19) United States
(12) Patent Application Publication
(10) Pub. No.: US 2018/0243746 A1
(43) Pub. Date: Aug. 30, 2018

(54) SYSTEM AND METHOD FOR ROLLER PRESS DRIVE REMOVAL

(71) Applicant: FLSmidth A/S, Valby (DK)

(72) Inventor: David Udy, Layton, UT (US)

(21) Appl. No.: 15/753,918

(22) PCT Filed: Nov. 23, 2016
(86) PCT No.: PCT/US2016/063519

§ 371 Date: Feb. 20, 2018

Related U.S. Application Data
(60) Provisional application No. 62/259,401, filed on Nov. 24, 2015.

(51) Int. Cl. B02C 4/02; B02C 4/42; B30B 3/04; B30B 15/04

(52) U.S. Cl. CPC B02C 4/02; B02C 4/42; F16C 13/02; B30B 15/04; B30B 3/04

(57) ABSTRACT

A comminution device configured to comminute material is disclosed. According to some embodiments the comminution device may comprise a first cylindrical roll having a first axis; and a second cylindrical roll having a second axis; wherein the first axis may be substantially parallel with the second axis to form a nip between the first cylindrical roll and the second cylindrical roll during operation of the comminution device. A first drive 50 may be operatively connectable to the first cylindrical roll, and a second drive 50 may be operatively connectable to the first cylindrical roll. The first drive 50 and the second drive 50 may be connected to a mount 10; wherein the mount 10 may be supported by an upper base 30. The mount 10 is movable along a direction (A-Axis), which is substantially parallel with the first and/or second axis. Also disclosed, is a drive assembly 1 for a comminution device and a method of removing a drive assembly 1 from a comminution device.

### CROSS-REFERENCE TO RELATED APPLICATIONS

This §371 National Stage application claims priority to, and claims the benefit of, U.S. Provisional Patent Application No. 62/259,401 filed on 24 Nov. 2015, and PCT/US2016/063519 filed on 23 Nov. 2016 which are both hereby incorporated by reference in their entirety, for any and all purposes, as if fully set forth herein.

### FIELD OF THE INVENTION

The present invention relates to devices configured to comminute material such as ore, rock, minerals, stone, agglomerated material, cement clinker, or other material. In particular, the present invention relates to roller presses (e.g., high pressure grinding roll devices), and systems and methods for decoupling, displacing, and/or removing drives from rolls.

### BACKGROUND OF THE INVENTION

Some types of crushing devices, such as roller presses (e.g., a high pressure grinding roll device), may have two rolls that are spaced apart from each other to define a nip therebetween. Material may be crushed or otherwise comminuted in the nip by virtue of the opposing rotation of the rolls. Examples of such devices may be seen from U.S. Pat. No. 7,841,552, US7,628,347, US7,510,135, US6,305,205, US5,542,618, US5,522,557, US4905910, US4,880,172, US4,140,285, US3,376,724, and US1,865,286; U.S. Patent Application Nos. 2007/0187538, 2008/0017052, and 2010/0206974; Japanese Patent Nos. JPH03248708, JP4395944, and JP9277244; European Patent Nos. EP0667186, EP1147815, and EP0801985; German Patent Nos. DE8604024, DE19522093, DE19619110, DE3723605, DE4110643,DE4314412; British Patent No. GB790337; Chinese publications CN2782213, CN2776542, CN2749567, CN201079742, and CN200981003; Russian Patent No. SU161140; and WIPO publications WO05102531, WO06099910, WO06084652, and WO10601225, without limitation.

Rolls typically have an outer surface used to compact and comminute material. Rolls may include a liner that defines an outer surface of the roll. The outer surface of a roll is typically formed of metal, ceramic, or a combination thereof, since it experiences a significant amount of wear during operation. Inserts, which may also be referred to as “studs”, may be positioned in the outer surface of the roll. The inserts may be composed of a material that is harder than other portions of the surface such as the liner of the roll or the outer surface of the roll. For instance, the inserts may be composed of carbide or tungsten carbide. The inserts help encourage the formation of an autogenous layer which forms and builds between the inserts, and it is this autogenous layer which helps protect the roll and slow the progression of wear.

Rolls often experience relatively high rates of wear, and as a result, they often have their wear surfaces replaced or repaired. When replacement or repair of a roll is needed, substantial costs in terms of lost operational capacity as well as labor costs associated with the repair or replacement of the roll can be incurred. For example, with some installations, it might not be uncommon for a medium-sized roller press to incur fifty to one-hundred thousand US dollars or more per hour of run downtime. Accordingly, a new design for a roller press (e.g., a nip-type high pressure grinding roll “HPGR” device) is needed. The new design should substantially reduce the time required by an operator to swap out a worn roll or drive (for repair or replacement of the roll or drive).

To date, conventional systems only allow a single drive to be removed from a roller press at one time, and therefore, conventional systems are inefficient in that they do not allow both drives (i.e., a set of two or more drives) to be removed simultaneously by one device. This limitation of conventional systems effectively doubles the amount of time needed to remove both drives for maintenance procedures. These same conventional systems further require partial or full disassembly of each drive (e.g., transmission portions), every time one or both drives need to be removed for drive maintenance or roll replacement. The aforementioned steps consume a great deal of time and can unnecessarily extend non-operational downtime, which leads to increased operating expenditures (OPEX).

To date, there are no available drive assembly solutions for roller press systems which can be quickly and easily employed, and which are configured to transform or convert an otherwise movable linkage assembly (e.g., a torque-sharing device including, but not limited to a torque arm device) into a substantially rigid drive mount that can be used to support dual drives and provide for lateral translation (e.g., planar or linear movement) of the drives in relation to the rolls they are designed to turn. Accordingly, it is desirable to provide an aftermarket/retrofit solution for converting existing articulated drive support devices to rigid mounts which can be moved towards or away from rolls using various means.

Moreover, many of the described conventional systems generally require the hanging of counterweights onto portions of each drive during maintenance procedures, in order to horizontally balance the drives, adjust the center of mass of the drives, and/or enable each drive to be individually lifted by a crane via a strap, chain, or other rigging. These extra balancing steps take extra time, expose workers to unnecessary safety hazards, and might require additional manpower and equipment which can extend machine downtime, increase OPEX costs, and even negatively affect profit margins.

### OBJECTS OF THE INVENTION

It would, therefore, be desirable to provide a drive assembly 1 for a roller press, which is configured with the ability to simultaneously move both drives 50 in a direction parallel to the axes of rolls connected thereto.

It is further desired to provide a drive assembly 1 which does not necessarily require moving portions of a main roller press frame, moving a cylindrical roll, and/or relocating roll bearings, when configuring a roller press to perform maintenance on a roll, drive, or motor.

It is further desired to improve upon conventional roller press designs by providing a manner in which aftermarket components, such as a locking member, may be used to with a torque reaction system, in order to ensure speedy and safe removal of reducer drives from their respective roll shafts and/or drive couplings.

These and other objects of the present invention will be apparent from the description herein. Although every object of the invention is believed to be attained by at least one embodiment of the invention, there is not necessarily any one embodiment of the invention that achieves all of the objects of the invention.

### SUMMARY OF THE INVENTION

According to some embodiments, a comminution device, such as a roller press (e.g., a high pressure grinding roll “HPGR” device) is disclosed. The comminution device may comprise a first cylindrical roll having a first axis, and a second cylindrical roll having a second axis. The first axis may be substantially parallel with the second axis to form a nip between the first cylindrical roll and the second cylindrical roll during operation of the comminution device. The comminution device may further comprise a drive assembly 1 comprising a first drive 50 operatively connectable to the first cylindrical roll, and a second drive 50 operatively connectable to the first cylindrical roll. The first drive 50 and the second drive 50 may be connected to a mount 10, wherein the mount 10 may be supported by an upper base 30. The mount 10 may be movable along a direction (A-Axis) which is substantially parallel with the first and/or second axis. Movement of the mount 10 along the A-Axis direction may be facilitated by a bearing 40. In some embodiments, the mount 10 may comprise a portion of a torque-sharing system, such as a portion of a torque arm, which can been locked from articulation using one or more locking member 60s, without limitation.

In some embodiments, said portion of a torque arm may comprise at least one link 16, at least one hinge 18, and/or at least one arm 12, 14 without limitation. In some embodiments, the portion of a torque arm may comprise at least two links 16, at least four hinges 18, an upper arm 12, and a lower arm 14 as shown, without limitation. In some embodiments, the mount 10 may comprise one or more locking members 60 which are configured to prevent the torque-sharing system from articulating, without limitation. For example, in some embodiments, the mount 10 may comprise one or more locking members 60 which are configured to prevent the at least one link 16 from articulating with the at least one arm 12, 14 (i.e., via said at least one hinge 18). A single locking member 60 may alone prevent articulation of a drive 50 relative to both upper 12 and lower 14 arms. Preferably, a locking member 60 is placed at least between a drive 50 and a lower arm 14 of the mount 10 to prevent articulation of the torque-sharing system, without limitation.

The comminution device may further comprise a lower base 70. In some embodiments, a bearing 40 may be provided between the upper base 30 and the lower base 70. The bearing 40 may comprise any type of linear, planar, or horizontally-arranged bearing configured to facilitate movement of the mount 10 in at least a direction (A-Axis) that is substantially parallel with the first and/or second axis, without limitation. As shown, at least one horizontal actuator 34 may be provided to an actuator mount 32 of the lower base 70 in order to facilitate movement of the upper base 30 relative to the lower base 70. The at least one horizontal actuator 34 may be configured to move the mount 10 along the direction (A-Axis) which is substantially parallel with the first and/or second axis. In some embodiments, at least one vertical actuator 36 may be provided to raise the upper base 30 in relation to the lower base 70. For example, the at least one vertical actuator 36 may be configured to move the upper base 30 with respect to the lower base 70 along a direction (B-Axis) which is substantially perpendicular to the first and/or second axis.

A drive assembly 1 for a comminution device is further disclosed. The comminution device may comprise a first cylindrical roll having a first axis; a second cylindrical roll having a second axis; the first axis being substantially parallel with the second axis to form a nip between the first cylindrical roll and the second cylindrical roll during operation of the comminution device. The drive assembly 1 may comprise a first drive 50 which is operatively connectable to the first cylindrical roll, and rigidly connected to a portion of a mount 10, such as to an upper 12 or lower 14 arm. The drive assembly 1 may further comprise a second drive 50 which is operatively connectable to the second cylindrical roll, and which is also rigidly connected to another portion of the mount 10, such as to the other one of said upper 12 or lower arm 14. By virtue of a bearing 40, the mount 10 is movable and may be moved along a direction (A-Axis) which is substantially parallel with an axis of either the first or second drive 50. The mount 10 may be able to articulate during operation in an operating configuration (FIGS. 3-5)—for example, an upper arm 12 of the mount 10 may be configured to move relative to a lower arm 14 of the mount 10 during operation, by virtue of a number of links 16 and hinges 18, so as to provide a torque-sharing function. The mount 10 may be precluded from articulation during maintenance by providing a maintenance configuration wherein a locking member 60 is positioned between at least one drive 50 and at least one arm 12, 14 of the mount, thereby preventing relative movement between upper arm 12 and lower arm 14.

Also disclosed, is a method of removing drives 50 of a comminution device (e.g., moving drives away from rolls), the comminution device comprising a first cylindrical roll having a first axis; a second cylindrical roll having a second axis; wherein the first axis is substantially parallel with the second axis to form a nip between the first cylindrical roll and the second cylindrical roll during operation of the comminution device. According to some embodiments, the method may comprise the step of simultaneously moving: a first drive 50 operatively connectable to the first cylindrical roll and rigidly connected to a mount 10, a second drive 50 operatively connectable to the second cylindrical roll and rigidly connected to the mount 10; and the mount 10 rigidly connected to the first drive 50 and second drive 50, together, away from the first cylindrical roll and the second cylindrical roll, in a direction (A-Axis) which is substantially parallel with either or both of the first and second axes, without limitation.

According to some embodiments, the method may comprise the step of attaching an adjustable member 90 between a lower arm 14 of the mount 10 and an upper base 30 supporting the mount 10. The adjustable member 90 may be connected to an upper base adjustable member attachment point 92 provided to the upper base 30; and the adjustable member 90 may be connected to a lower arm adjustable member attachment point 94 provided to the lower arm 14, without limitation.

According to some embodiments, the method may comprise the step of raising an upper contact portion 82 of a drive support frame 80, and contacting a portion of the first drive 50 and/or the second drive 50 with the upper contact portion 82. The drive support frame 80 may be provided as a vertical extension portion of the upper base 30, as shown, without limitation. As shown, separate upper contact portions 82 may be provided, each upper contact portion 82 contacting its own separate drive 50; however, while not shown, a single upper contact portion 82 may be provided which may serve to contact both drives 50. According to some embodiments, the step of raising an upper contact portion 82 of a drive support frame 80 may comprise engaging (e.g., turning or pumping) a number of jacks 84, or the like, provided between a vertical support member 86 and the upper contact portion 82. The method may comprise the step of contacting a portion of the first drive 50 and/or the second drive 50 with the upper contact portion 82, and this may involve contacting a top of the upper contact portion 82 of the drive support frame 80 with a rear flange 53 of the first and/or second drive 50, as shown, without limitation. The method may comprise the step of uncoupling roll mounts 52 of the first and second drives 50 from drive couplings 51 of their respective cylindrical rolls by removing or disengaging fastener portions 55. As shown, roll mounts 52 and drive couplings 51 may be configured as flanges which may comprise key portions for accommodating a key 54 therebetween. The method may comprise the step of raising the upper base 30 using a vertical actuator 36, and contacting a portion of the upper base 30 to a portion of the lower arm 14, such as a flange portion 24 of a gusset 20 (e.g., in order to support mount 10 and drives 50 connected thereto). The method may comprise the step of actuating a horizontal actuator 34 to move the upper base 30 relative to a lower base 70 (e.g., along an A-Axis), via a bearing 40 therebetween. The method may comprise the step of securing the horizontal actuator 34 to an actuator mount 32 located on the upper base 30 prior to said step of actuating. Securement of horizontal actuator 34 to the base 30 may be accomplished with a strap, pin, clamp, or bolt, without limitation.

Other details, objects, and advantages of the invention will become apparent as the following description of certain present preferred embodiments thereof and certain present preferred methods of practicing the same proceeds.

### BRIEF DESCRIPTION OF THE DRAWINGS

Present preferred embodiments of a drive assembly for crushing devices having cylindrical rolls are shown in the accompanying drawings and certain present preferred methods of practicing the same are also illustrated therein. It should be appreciated that like reference numbers used in the drawings may identify like components.

FIG. 1 is a frontal isometric three dimensional image of a first non-limiting embodiment of a drive assembly for a crushing device.

FIG. 2 is a rear isometric three dimensional image of the first non-limiting embodiment of a drive assembly for a crushing device shown in FIG. 1.

FIG. 3 shows a rear isometric three dimensional image of a second non-limiting embodiment of a drive assembly assembled to a crushing portion of a crushing device in an operating configuration.

FIG. 4 shows a side view of the crushing device shown in FIG. 3.

FIG. 5 shows a frontal isometric view of the drive assembly shown in FIGS. 3 and 4, but without the crushing portion of the crushing device for clarity.

FIG. 6 shows a rear isometric three dimensional image of the second non-limiting embodiment shown in FIGS. 3-5, in a non-operating maintenance configuration.

FIG. 7 shows a side view of the crushing device shown in FIG. 6.

FIG. 8 shows a frontal isometric view of the drive assembly shown in FIGS. 6 and 7, but without the crushing portion of the crushing device for clarity.

FIGS. 9 and 10 show a close-up view of a locking member according to some embodiments.

In the following, the invention will be described in more detail with reference to drawings in conjunction with exemplary embodiments.

### DETAILED DESCRIPTION OF PREFERRED EMBODIMENTS

A crushing device, in particular, a roller press, such as a high pressure grinding roll device (i.e., “HPGR”) may include a crushing portion having pair of cylindrical rolls rotationally-supported at their ends and generally oriented with their axes substantially parallel with one another to define a roller nip therebetween. Feed material may enter the roller nip during comminution, and the roller nip may widen and contract, or otherwise vary over time depending on grinding pressure exerted or experienced. If the cylindrical rolls skew, the roller nip shape may change from rectangular to trapezoidal or wedge-shaped, without limitation.

Each roll may comprise a drive coupling 51 which is adequately configured to be coupled to a drive assembly 1. For example, each drive coupling 51 may be adequately configured to be coupled to a respective roll mount 52 of a respective drive 50. In some embodiments, a drive coupling 51 may be configured as a flange comprising a number of fastener portions 55 thereon, as shown. In some embodiments, a fastener portion 55 may comprise an opening configured to receive a fastener, and/or it may comprise a fastener configured to be received within the opening, without limitation. In some embodiments, a fastener portion 55 may comprise a first part of a fastener (e.g., a nut) intended to mate, fasten or operatively connect with a second part of a fastener (e.g., a bolt), without limitation. In some embodiments, a fastener portion 55 may comprise a first part of a fastener (e.g., a bolt) intended to mate, fasten or operatively connect with a second part of a fastener (e.g., a nut), without limitation. A fastener portion 55 may comprise an opening and one or more fasteners (e.g., nuts, bolts) provided within the opening or surrounding the opening, without limitation.

In some embodiments, each roll may comprise a drive coupling 51 which may be configured as a flange having a number of openings thereon, the openings being configured to receive fasteners of the bolt and/or nut type, without limitation. Similarly, in some embodiments, each roll mount 52 may be configured as a flange having a number of openings thereon, the openings being configured to receive fasteners of the bolt and/or nut type, without limitation. Preferably, the number of fastener portions 55 provided to the drive coupling 51 is complementary to the number of fastener portions 55 provided to its respective roll mount 52. Where the term is used herein, “openings” may be of the clearance type, press-fit type, or threaded type, without limitation.

The interface between each drive coupling 51 and its respective roll mount 52 preferably comprises a key 54 or other device adapted to assist with torque transfer. The key 54 preferably mates with corresponding complementary key portions provided to each drive coupling 51 and roll mount 52 as will be apparent hereinafter and from the appended drawings. For example, a key 54 may be provided between the drive coupling 51 and an adjacent roll mount 52, and the key 54 may be permanently or non-permanently affixed to either one of the two, without limitation. In the embodiment shown, a key 54 is provided so as to be semi-permanently attached to each roll mount 52, such that the key 54 is configured to mate with a corresponding complementary key portion of a drive coupling 51.

To drive the pair of rolls, a drive assembly 1 may be provided between two motors (not shown not shown for clarity) and two respective cylindrical rolls (also not clearly shown) of a crushing portion of the crushing device. Referring to the figures, the drive assembly 1 may comprise a mount 10 which simultaneously supports two drives 50. Drives 50 may comprise a transmission, gear box, reducer, gearing, gearing housing, and/or the like, without limitation. The drives 50 are preferably co-axially aligned with the cylindrical rolls and are preferably aligned with each other, such that the drive axes are substantially parallel to each other. The mount 10 may be provided as a generally planar member which may be positioned generally orthogonally with the axes of the drives 50 (and therefore generally orthogonally with the axes of rotation of their output shafts).

In some embodiments, the mount 10 may be comprised of one or more portions of a torque sharing system, as shown, without limitation. For example, in some embodiments, the mount 10 may comprise a portion of a torque arm or a complete torque arm (e.g., see for example, the torque arm described in Applicant's own U.S. Pat. No. 5,542,618). In some non-limiting preferred embodiments, the mount 10 may comprise an upper arm 12 having a lower edge 13 defining a portion of a large opening, a lower arm 14 having an upper edge 11 defining another portion of said large opening, one or more links 16 connecting the upper arm 12 to the lower arm 14 (e.g., at ends of the arms 12, 14), at least one hinge 18 (e.g., pivot, bolt, pin, knuckle, joint member) provided between the one or more links 16 and the upper arm 12, and at least one hinge 18 (e.g., pivot, bolt, pin, knuckle, joint member) provided between the one or more links 16 and the lower arm 14, without limitation.

One or more fastener portions 15 may be provided to the upper arm 12 for securing a drive 50 to the mount 10, whilst still allowing for articulation between the upper 12 and lower 14 arms during operation. For example, in the non-limiting embodiment shown, a securing flange 58 of a first drive 50 may be operatively coupled to the upper arm 12 via one or more fastener portions 15. A fastener portion 15 may comprise, for instance, a hole(s), aperture(s), or opening(s) for a bolt(s) as shown, without limitation. Similarly, one or more fastener portions 17 may be provided to the lower arm 14 for securing a drive 50 to the mount 10, whilst still allowing for articulation between the upper 12 and lower 14 arms during operation. For example, a securing flange 58 of a second drive 50 may be operatively coupled to the lower arm 14 via one or more fastener portions 17. A fastener portion 17 may comprise, for instance, a hole(s), aperture(s), or opening(s) for a bolt(s) as shown, without limitation. In some embodiments, fastener portions 15, 17 may comprise a clamp(s) or member(s) of a clamping device, without limitation.

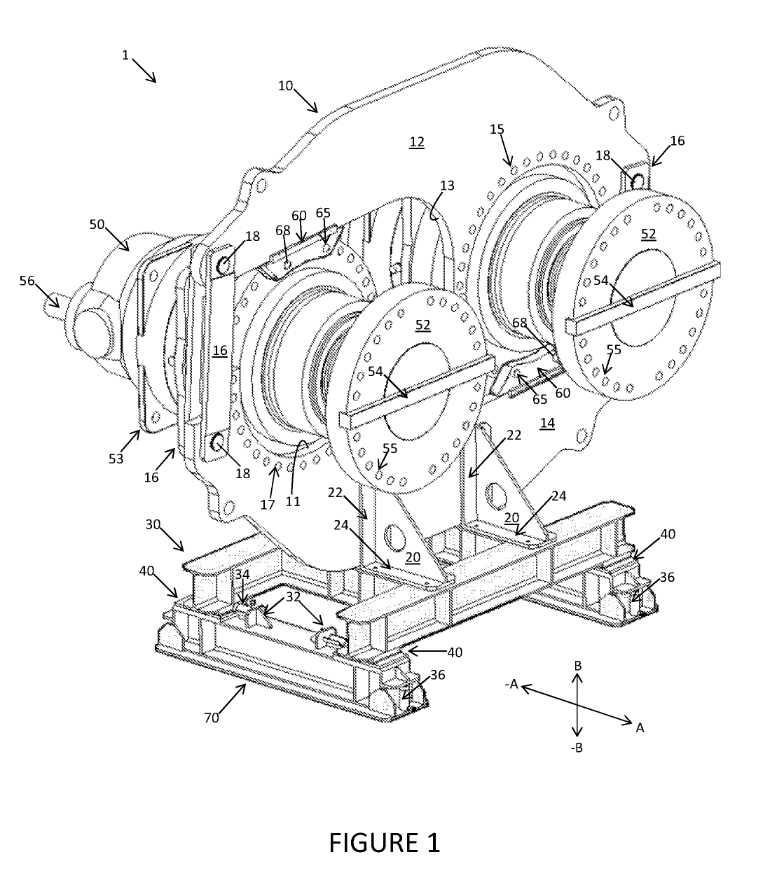

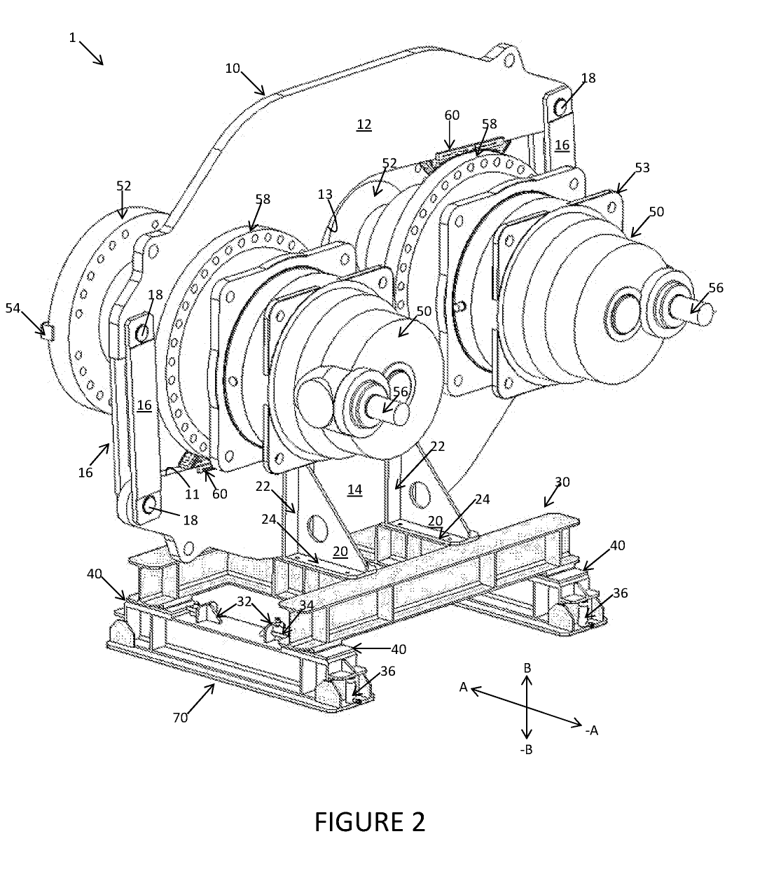

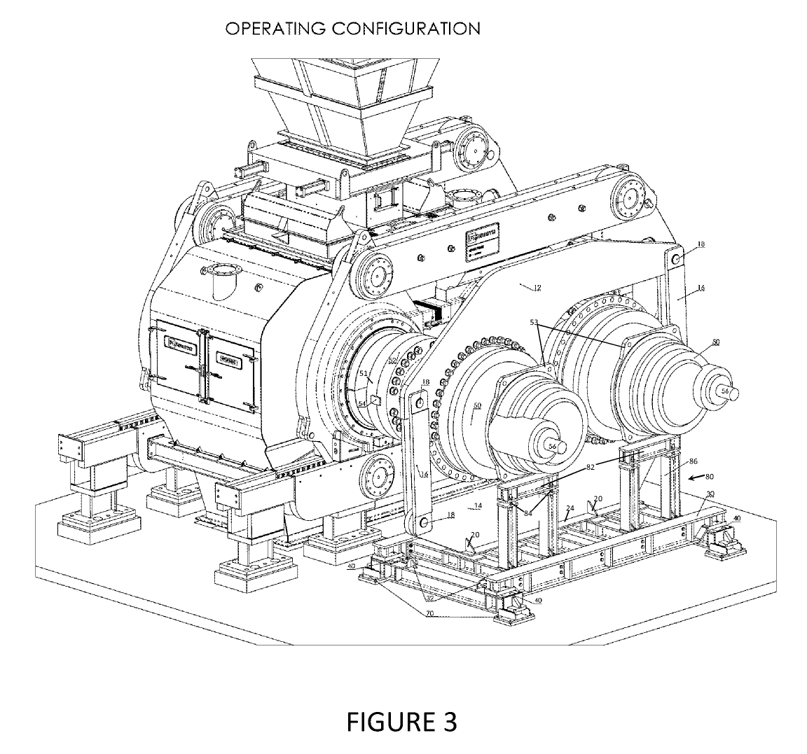

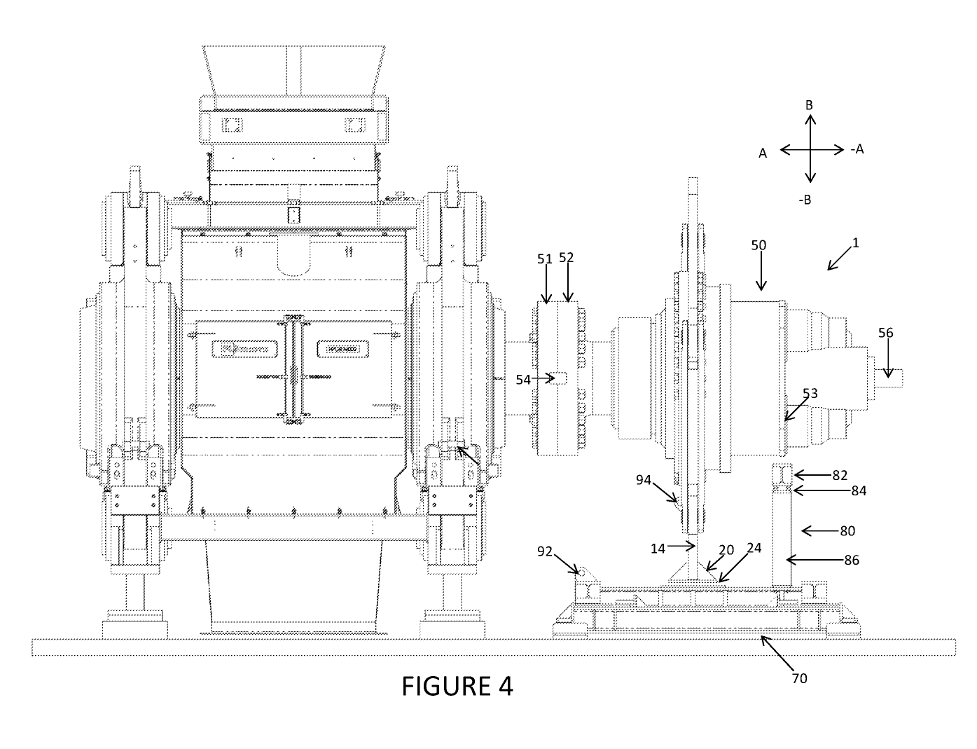

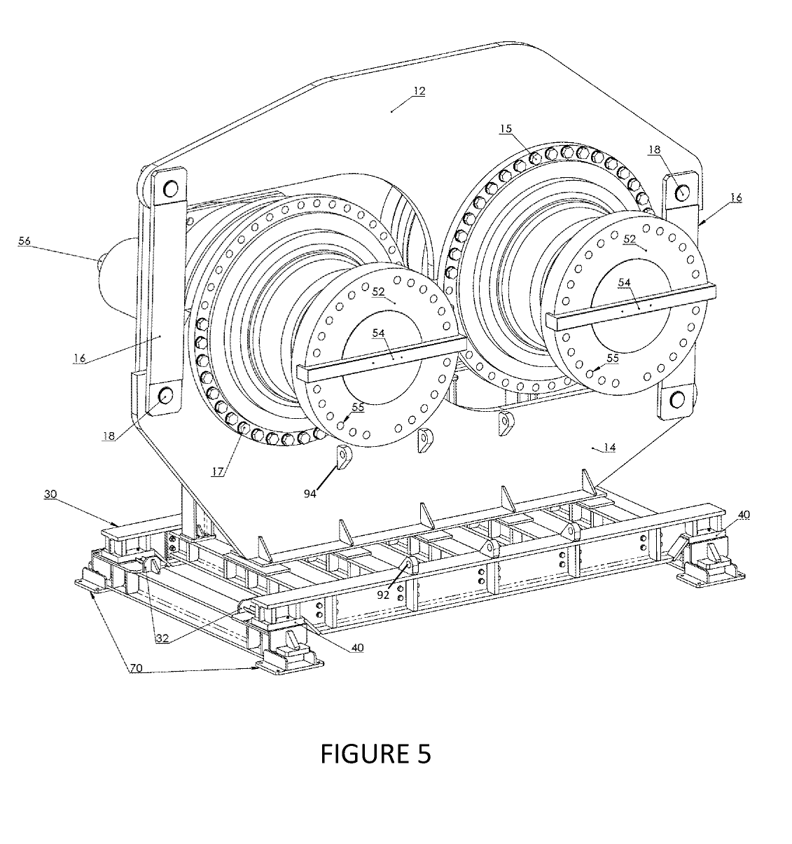

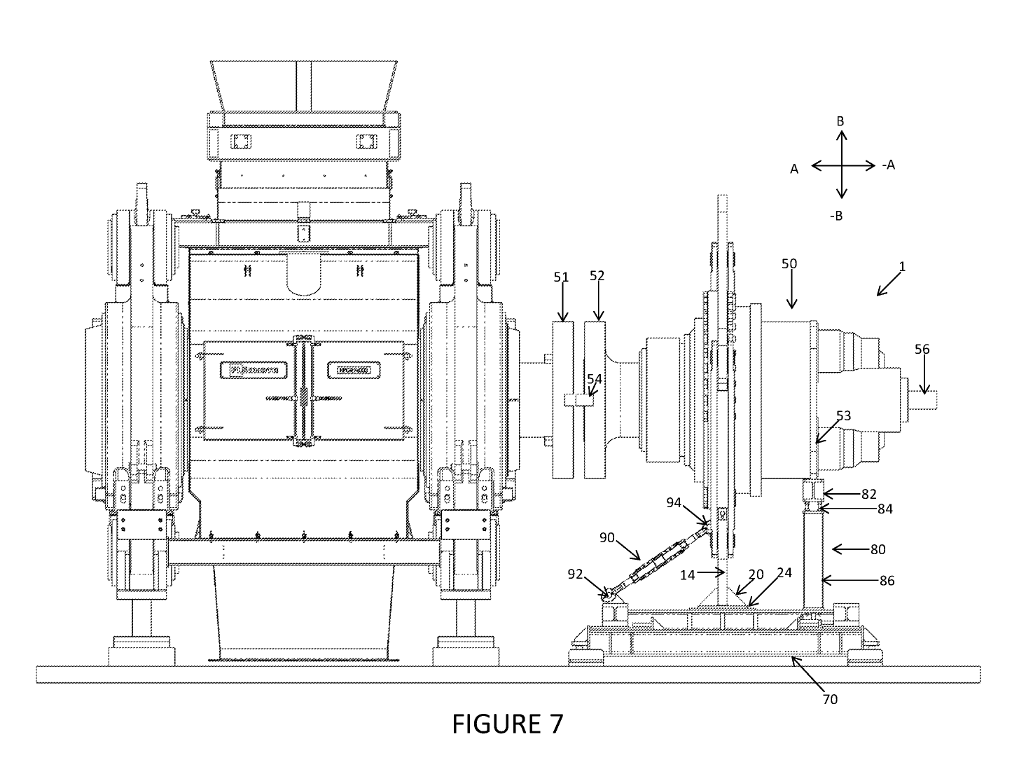

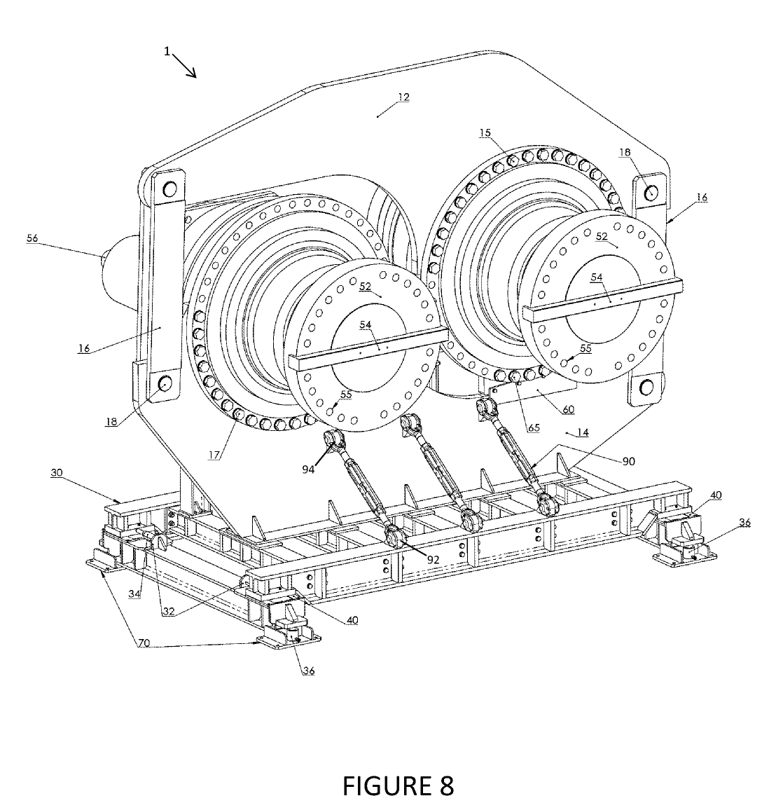

Optionally, one or more gussets 20 (e.g., a number of protruding brackets) may be employed to the lower arm 14, in order to secure the mount 10 to an upper base 30 or stabilize the mount 10 relative to the upper base 30. As shown in FIGS. 1 and 2, a gusset 20 may comprise a mount attachment portion 22 and a lower arm flange portion 24 for engaging the upper base 30. As shown in FIGS. 3-8, a gusset 20 may be integrally-welded to a lower arm 14 and may only comprise a lower arm flange portion 24 for engaging the upper base 30. As shown in the figures, in some embodiments, one or more gussets may be provided to opposing sides of a generally planar lower arm 14, without limitation. As shown in FIGS. 1 and 2, in some embodiments, the mount attachment portion 22 (if/when employed) may be substantially vertically oriented (e.g., in a B-Axis direction). The mount attachment portion 22 may be used for attaching gussets 20 to a substantially vertically-oriented planar mount 10 (e.g., via bolting, clamping, or welding). The lower arm flange portion 24 may be substantially horizontally-oriented (e.g., in an A-Axis direction which is orthogonal to the B-Axis direction) for attachment to a substantially horizontally-oriented upper base 30, without limitation. As suggested by FIG. 4, the lower arm flange portion 24 need not be physically attached to the upper base 30, but it may contact the upper base 30 when the drive assembly 1 is in a maintenance configuration (FIG. 7).

The upper base 30, the one or more gussets 20, and the mount 10 may all be collectively supported by a lower base 70 as shown. In some embodiments, as shown, the lower base 70 may simply comprise a parallel set of beams, rails, or tracks. Alternatively, while not shown, the lower base 70 may comprise a vertically-movable floor member, a vertically-movable platform, a vertically-movable supporting structure, a vertically-movable foundation, or a vertically-movable frame, without limitation. A bearing 40 (e.g., a linear or planar bearing allowing horizontal movement) may be provided between the lower base 70 and at least one of: the upper base 30, the one or more gussets 20, and/or the mount 10 (in general). The bearing 40 may simply comprise a low friction planar surface, or, it may comprise a rail(s) with a wheel(s), a roller bearing, a track, or the like, without limitation. A portion of the bearing 40 may be incorporated into lower arm flange portions 24, without limitation.

One or more permanent or temporary actuator mounts 32 may be provided to various portions of the upper base 30 and/or to the lower base 70, without limitation. For example, in the non-limiting preferred embodiments shown, four horizontally-arranged actuator mounts 32 may be provided to the lower base 70, wherein two of the horizontally-arranged actuator mounts 32 may be juxtaposed with the other two horizontally-arranged actuator mounts 32. One or more horizontal actuators 34 may be permanently secured to each horizontally-arranged actuator mount 32. Alternatively, as shown, it may be preferred that one or more horizontal actuators 34 are temporarily moved back and forth and between the horizontally-arranged actuator mounts 32, and utilized, as necessary, intermittently, in order to incrementally move the upper base 30 relative to the lower base 70, without limitation. In some embodiments, the one or more horizontal actuators 34 may comprise a hydraulic cylinder or a jack (e.g., jackscrew, hand jack, or the like), without limitation. Horizontal actuators 34 may be configured for imparting relative movement of the mount 10 and drives 50 connected thereto, along the A-Axis, relative to the lower base 70.

One or more of the actuator mounts 32 provided to the various portions of the upper base 30 and/or lower base 70 may be vertically arranged. For example, in the non-limiting embodiment shown, one or more vertical actuators 36 are positioned between the lower base 70 and the upper base 30, and they may be used to impart relative (vertical) movement between the upper base 30 and lower base 70. Accordingly, the one or more vertical actuators 36 may be configured to move drives 50 along a B-Axis direction which is roughly orthogonal to the A-Axis (i.e., horizontal) direction. The vertical actuators 36 may be permanently affixed to portions of the drive assembly 1; or, they may be configured to be removed from the drive assembly 1 prior to operation. They may be used, as necessary, to: a) locate the drives 50 in a preferred three dimensional location/spatial orientation, b) position and/or move the drives 50 relative to the cylindrical rolls and drive couplings 51 provided thereto, c) temporarily reduce friction imposed on bearing 40, and/or d) position and move the drives 50 relative to the motors which they are intended to be attached to, such that the motors (not shown) can be aligned with inputs 56, without limitation. In some embodiments, the one or more vertical actuators 36 may comprise a hydraulic cylinder, or a jack (e.g., a jackscrew, hand jack, or the like), or other device suited for moving the drives 50 in the B-Axis direction, without limitation.

According to some embodiments, the mount 10 may be provided from portions of a torque-sharing system. Accordingly, mount 10 may comprise one or more torque arm portions of a roller press. For example, as shown, the mount 10 supporting the two drives 50 may comprise an upper 12 and lower 14 arm, without limitation. One or more locking members 60 may be used to rigidly secure the drives 50 to portions of the mount 10, and/or to prevent portions of the mount 10, such as the upper arm 12, from moving relative to other portions of the mount, such as the lower arm 14. In instances where the mount 10 is provided using portions of a torque-sharing system, the locking members 60 may prevent or limit articulation of hinges 18 and therefore prevent or limit movement of links 16 connected to respective upper 12 and lower arms 14. The locking members 60 may come in many forms including, but not limited to: blocks, turnbuckles, springs, bushings, or the like, without limitation.

A single locking member 60 (FIGS. 3-8), or a plurality of locking members 60 (FIGS. 1-2) can be employed in a maintenance configuration. For example, a locking member 60 may be placed between a drive 50 and a lower arm 14. A locking member 60 may also optionally be placed between another drive 50 and an upper arm 12. In the particular non-limiting embodiment shown in FIGS. 1 and 2, a first locking member 60 is used to secure a first drive 50 to the upper arm 12, and a second locking member 60 is used to secure a second drive 50 to the lower arm 14. However, it is envisaged that multiple locking members 60 may be provided to secure each drive 50 to respective arms 12, 14. Each locking member 60 may, as shown, comprise one or more first fastener portions 65, and one or more second fastener portions 68, without limitation. First fastener portions 65 may comprise one or more holes, apertures, or openings for fasteners such as nuts and/or bolts, without limitation. The one or more holes, apertures, or openings for fasteners may include fasteners, such as nuts or threaded holes, apertures, or openings, without limitation. Second fastener portions 48 may comprise one or more bolts, nuts, pins, safety wire, etc., without limitation. For example, a second fastener portion 68 may comprise an elongated fastener which extends through a first fastener portion 65, without limitation.

In the particular embodiment shown, a second fastener portion 68 comprises a bolt which is provided through an opening (i.e., first fastener portion 65) in the locking member 60. The mechanical connection shown and described may be duplicated with any level of redundancy. For example, as shown, two openings and two bolts are shown for each locking member 60, but the number of first 65 and second 68 fastener portions could be larger in number, without limitation.

While not shown, a locking member 60 may be omitted, and one or more first fastener portions 65 may directly rigidly connect a drive 50 to the mount 10. For example, a number of nuts and bolts may engage fastener portions 55 provided to a securing flange 58, wherein the fastener portions 55 are openings. In doing, a drive 50 may be directly secured to an upper arm 12 or to a lower arm 14, without the need for a separate locking member 60. In some embodiments, studs may be provided to extend from the securing flange 58, and the studs may connect with fastener portions 15, 17 provided to the upper 12 and lower 14 arms to serve as a locking member 60, without limitation.

Nuts, bolts, and openings configured to receive the same may be provided as fastener portions 55. The fastener portions 55 may be configured to secure the roll mounts 52 to their complimentary drive couplings 51. Each drive coupling 51 may be operably connected to and may extend from its respective cylindrical roll. Keying means or other means for torque transfer may be employed without limitation. For example, a key 54 may be provided between a drive coupling 51 and a roll mount 52 as shown. While not shown, roll pins, shear pins, set screws, locking screws, and other methods of connecting two flanges together which are known in the arts are also anticipated. Moreover, a shrink disk (not shown for clarity) may be used to connect the roll mount 52 to the drive coupling 51, without limitation. Each drive 50 may further comprise an input 56 (e.g., an input drive shaft, a motor coupling, or the like) to receive and transfer an input torque or rotational force. Each input 56 is preferably easily connectable and disconnectable to an output shaft of a drive motor (not shown for clarity).

According to some embodiments, the removal of drives 50 from cylindrical rolls of a roller press may be performed with the assistance of a drive assembly 1 which may be configured to adequately support the rolls and/or their respective drives 50 during operation and/or maintenance, as well as serve as a torque-sharing device. The drive assembly 1 may also be adequately configured to enable the retraction of the drives 50 (which normally extend from their respective rolls during operation).

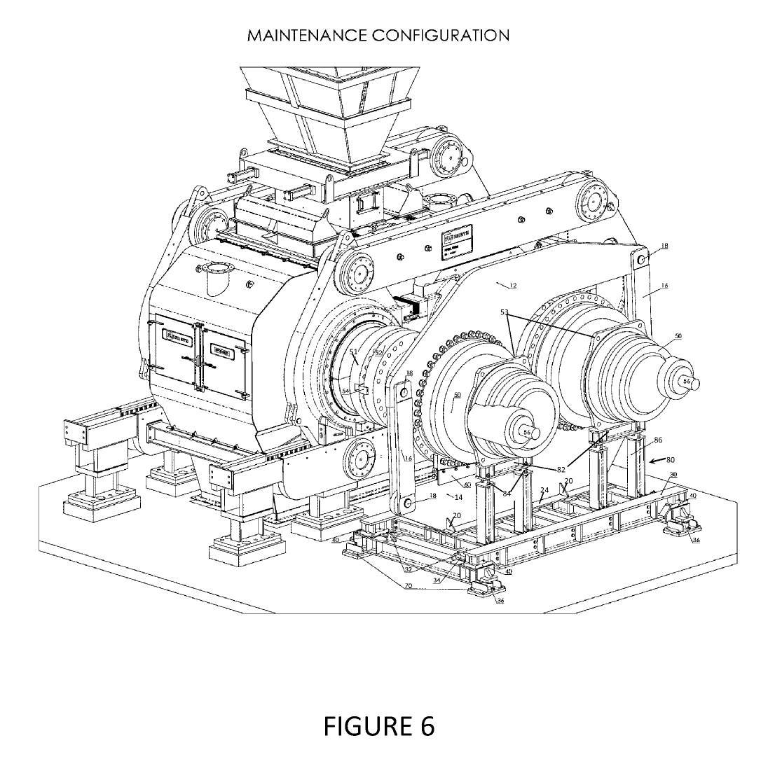

For example, in an operating configuration (FIGS. 3-5), the drive assembly 1 is preferably suited to share torque between two cylindrical rolls. When in a maintenance configuration (FIGS. 6-8), the drive assembly 1 may assist with the replacement of a roll and/or drive 50 during maintenance operations, by supporting the loads of the drives 50. Accordingly, the drive assembly 1 may be used during the operation of a roller press, and during maintenance operations of a roller press, albeit in different configurations.

According to some embodiments, an operating configuration may be employed (see FIGS. 3-5). Placing the drive assembly 1 into the operating configuration may comprise removing a locking member 60 from an upper edge portion 11 of the lower arm 14. Placing the drive assembly 1 into the operating configuration may further comprise removing the locking member 60 from a lower edge portion 13 of the upper arm 12 (e.g., if a second locking member 60 is used). Placing the drive assembly 1 into the operating configuration may further comprise positioning the upper base 30 in a low position (e.g., its lowest position allowable by vertical actuators 36), so that there is: a) sufficient clearance between the top of the upper base 30 and the bottom of the lower arm 14, b) sufficient clearance between the lower arm flange portion(s) 24 of gusset(s) 20, and/or c) sufficient clearance between the upper contact portion 82 of drive support frame 80 and the drives 50 (e.g., at rear flanges 53). In the operating configuration, vertical actuators 36 may be removed from the drive assembly 1 and stored separately until maintenance is necessary. Moreover, in the operating configuration, horizontal actuators 34 may be removed from the drive assembly 1 and stored separately until maintenance is necessary. Moreover, in the operating configuration, roll mounts 52 may be assembled to drive couplings 51, for example, via the key 54 and fastener portions 55, without limitation. Moreover, in the operating configuration, adjustable members 90 (i.e., turnbuckles) may be loosened and/or removed from the drive assembly 1. As shown, the one or more adjustable members 90 may be completely removed from one or more respective upper base adjustable member attachment points 92 and/or completely removed from one or more respective lower arm adjustable member attachment points 94 in the operation configuration (FIG. 4). However, it is also contemplated that the one or more adjustable members 90 can alternatively be loosened and left partially in place during an operation configuration.

In the operating configuration, one or more drive support frames 80 provided to the upper base 30 may be lowered or placed in its lowest position, so that there is sufficient clearance between the top of an upper portion 82 of the one or more drive support frames 80 and one or more drives 50. For example, as shown, in the operating configuration, a drive support frame 80 may be lowered or placed in its lowest position, by engaging one or more jacks 84 (e.g., by turning a jackscrew or levering a hydraulic hand jack, without limitation), so that there is sufficient clearance between the top of an upper portion 82 of the drive support frame 80 and a lower edge of a rear flange 53 of its respective drive 50, without limitation. As shown, two drive support frames 80 may be employed, one for each drive 50, and the two support frames 80 may be positioned so as to provide balanced support for the drives 50. In some preferred embodiments, the drive support frame 80 may comprise a vertical support member 86 that is welded, bolted, or otherwise connected to the upper base 30. The drive support frame 80 may comprise two vertical support members 86 connected by an upper contact portion 82 via one or more jacks 84. As shown, the upper contact portion 82 may comprise a cross-beam connecting two vertical support members 86 extending in a direction (B-Axis) which is substantially perpendicular to the first axis, the second axis, and/or the A-axis.

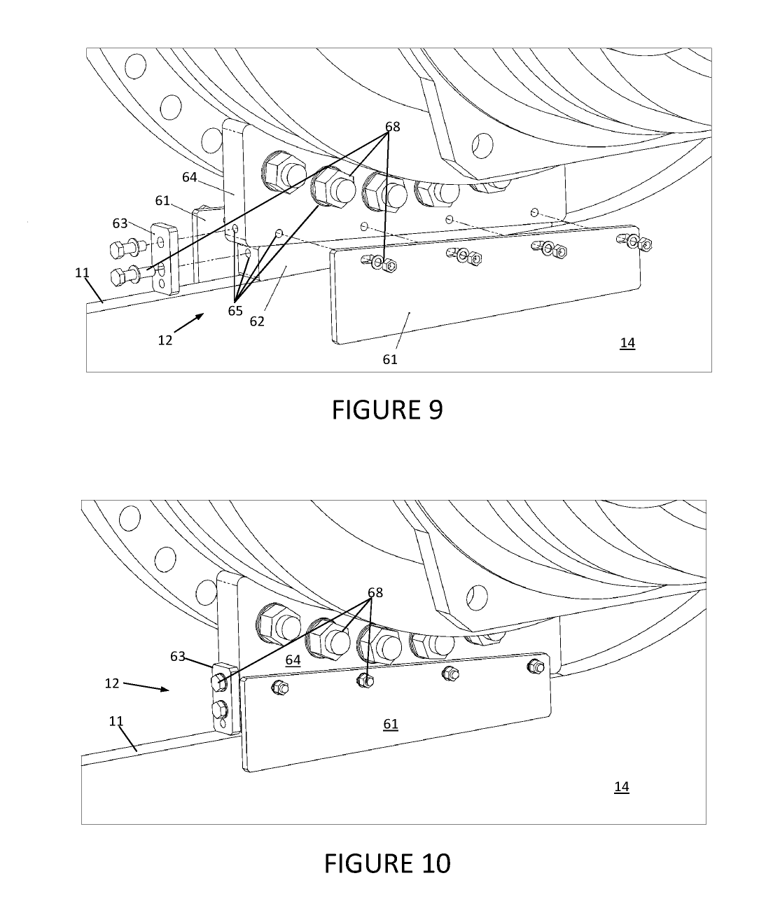

According to some embodiments, a maintenance configuration may be employed when the roller press is not in service (see FIGS. 6-8). Setting up the drive assembly 1 for its maintenance configuration may comprise providing a locking member 60 to an upper edge portion 11 of the lower arm 14. Optionally, setting up the drive assembly 1 for its maintenance configuration may further comprise providing a locking member 60 to lower edge portion 13 of the upper arm 12. The locking member(s) 60 may be installed with fastener portions 65, 68. In some embodiments, a wedge member 62 may be pushed between a cradle 64 and the upper edge portion 11 of the lower arm 14 and secured using a wedge install/retract plate 63. The cradle 64 may sit between the wedge member 62 and a drive 50. The wedge install/retract plate 63 may be fastened to an edge of the wedge member 62, such as in the manner shown in FIGS. 9 and 10, without limitation. In some embodiments, side support plates 61 may be affixed to either side of the cradle 64 via fastener portions 65, 68 as shown in FIGS. 9 and 10, without limitation. In some embodiments, while not shown, side support plates 61 may be affixed to either side of the wedge member 62 via fastener portions, without limitation.

Moreover, in setting up the drive assembly 1 for its maintenance configuration, the upper base 30 may be raised using vertical actuators 36, until the upper base 30 fully contacts the bottom of lower arm 14, or until the upper base 30 contacts a lower arm flange portion 24 of the lower arm 14 as shown in the lower right-hand portion of FIG. 7. The drive support frames 80 may be raised, for example, using jacks 84, until the top of the contact portions 82 contact/engage the lower edges of each rear drive flange 53, thereby supporting a portion of the weight of drives 50 and balancing the loads of the drives 50 across the upper 30 and lower 70 bases, without limitation.

In the maintenance configuration shown in FIGS. 6-8, one or more adjustable members 90 (i.e., turnbuckles, threaded bars, adjustable kickstands, adjustable truss members with multiple holes and clevis pin, or the like) may be installed to attach the upper base 30 to the lower arm 14. For example, if the center of mass of the drives favors a rear side of the mount 10, then turnbuckles may be employed and tightened as shown, in order to better stabilize the drive assembly 1 in its maintenance configuration. If the adjustable members 90 are configured to be employed during both operation and maintenance configurations, or, if the adjustable members 90 are already provided to the drive assembly 1 in an operating configuration, they may be adjusted (e.g., tightened) as necessary in order to remove slack in the drive assembly 1. As shown, the one or more adjustable members 90 may be connected to one or more respective upper base adjustable member attachment points 92 and to one or more respective lower arm adjustable member attachment points 94 in a maintenance configuration (FIG. 7). Fastener portions 55 may be removed from the drive couplings 51 and roll mounts 52 in the maintenance configuration, so that relative movement in the A-Axis direction can be established between the drives 50 and their respective rolls. Moreover, in the maintenance configuration, horizontal actuators 34 may be used to push and/or pull the drives 50 along the Axis-A, and away from the rolls in the A-Axis direction, without limitation.

Where used herein, the terms “comminution device,” “crushing device,” “roller press,” “HPGR,” or “high pressure grinding roll device” may be used interchangeably, without limitation. Where used herein, the term “opening” may comprise an “aperture,” without limitation. Where use herein, the term “fastener portion” may comprise any one or more portions of a mechanical fastening system known in the art including, but not limited to, openings, holes, apertures, bolts, nuts (e.g., castellated), countersinks, anti-rotation washers, lock rings, anti-rotation safety wire, threaded holes, etc. While certain present preferred embodiments of a drive removal system and methods of using the same have been shown and described, it is to be distinctly understood that the invention is not limited thereto but may be otherwise variously embodied and practiced within the scope of the following claims.

### LISTING OF ENUMERATED FEATURES IN THE DRAWINGS

1 Drive assembly

10 Mount

11 Edge defining opening

12 Upper arm

13 Edge defining opening

14 Lower arm

15 Fastener portion (e.g., hole(s) or opening(s) or nut(s) for bolts)

16 Link

17 Fastener portion (e.g., hole(s) or opening(s) or nut(s) for bolts)

18 Hinge (e.g., pivot, bolt, pin, knuckle, joint member)

20 Gusset (e.g., bracket)

22 Mount attachment portion

24 Lower arm flange portion

30 Upper base

32 Actuator mount

34 Horizontal actuator (e.g., movement along A-Axis)

36 Vertical actuator (e.g., movement along B-Axis)

40 Bearing (e.g., linear, planar, horizontal)

50 Drive (e.g., transmission, gear box, reducer, gearing housing)

51 Drive coupling

52 Roll mount

53 Rear flange

54 Key

55 Fastener portion (e.g., hole(s) or opening(s) or nut(s) for bolts)

56 Input (e.g., input drive shaft, input coupling, motor coupling)

60 Locking member (e.g., Upper arm locking member, Lower arm locking member)

61 Side support plate

62 Wedge member

63 Wedge install/extract plate

64 Cradle

65 Fastener portion (e.g., hole(s) or opening(s) or nut(s) for bolts)

68 Fastener portion (e.g., bolt(s), pin(s), nut(s), etc.)

70 Lower base

80 Drive support frame

82 Upper contact portion

84 Jack(s) (e.g., hand jack, jack screw, portable jack, hydraulic jack)

86 Vertical support member(s)

90 Adjustable member (e.g., turnbuckle(s))

92 Upper base adjustable member attachment point

94 Lower arm adjustable member attachment point

What is claimed is:

1. A comminution device comprising:
a first cylindrical roll having a first axis;
a second cylindrical roll having a second axis;
the first axis being substantially parallel with the second axis to form a nip between the first cylindrical roll and the second cylindrical roll during operation of the comminution device; and,
a drive assembly 1 comprising a first drive 50 operatively connectable to the first cylindrical roll; a second drive 50 operatively connectable to the second cylindrical roll; and a mount 10; characterized in that
the first drive 50 and the second drive 50 are connected to the mount 10;
the mount 10 is supported by an upper base 30; and
the mount 10 is movable along a direction (A-Axis) which is substantially parallel with the first and/or second axis, via a bearing 40.

2. The comminution device of claim 1, wherein the mount 10 comprises a portion of a torque-sharing system.

3. The comminution device of claim 2, wherein the mount 10 comprises at least one link 16, at least one hinge 18, and at least one upper 12 or lower 14 arm.

4. The comminution device of claim 3, wherein the mount 10 comprises one or more locking members 60 which are configured to prevent the at least one link 16 from articulating with the at least one upper 12 or lower 14 arm in a maintenance configuration.

5. The comminution device of claim 4, wherein the mount 10 comprises at least two links 16, at least four hinges 18, an upper arm 12, and a lower arm 14.

6. The comminution device of claim 5, further comprising a lower base 70.

7. The comminution device of claim 6, wherein the bearing 40 is provided between the upper base 30 and the lower base 70.

8. The comminution device of claim 7, wherein the bearing 40 is a linear or planar bearing oriented for permitting horizontal movement of the mount 10 in at least said direction (A-Axis) which is substantially parallel with the first and/or second axis.

9. The comminution device of claim 8, further comprising at least one horizontal actuator 34 which is configured to move the mount 10 along the direction (A-Axis) which is substantially parallel with the first and/or second axis.

10. The comminution device of claim 9, further comprising at least one vertical actuator 36 which is configured to move the upper base 30 with respect to the lower base 70 along a direction (B-Axis) which is substantially perpendicular to the first and/or second axis.

11. The comminution device of claim 10, further comprising a drive support frame 80 provided to the upper base 30, wherein the drive support frame 80 comprises at least one vertical support member 86, an upper contact portion 82, and a number of jacks 84 therebetween, wherein the drive support frame 80 is configured to support the first drive 50 and/or the second drive 50 in a maintenance configuration.

12. The comminution device of claim 11, further comprising an adjustable member 90 provided between the lower arm 14 and the upper base 30.

13. The comminution device according to claim 4, wherein the one or more locking members 60 comprises a wedge member 62 held between a cradle 64, and the lower arm 14.

14. The comminution device according to claim 13, wherein the one or more locking members 60 further comprises a wedge install/extract plate 63 operably connected to the wedge member 62.

15. The comminution device according to claim 14, wherein the one or more locking members 60 further comprises two side support plates 61.

16. A drive assembly 1 for a comminution device, the comminution device comprising a first cylindrical roll having a first axis; a second cylindrical roll having a second axis; wherein the first axis being substantially parallel with the second axis to form a nip between the first cylindrical roll and the second cylindrical roll during operation of the comminution device; the drive assembly comprising:
a first drive 50 operatively connectable to the first cylindrical roll rigidly connected to a mount 10; and,
a second drive 50 operatively connectable to the second cylindrical roll rigidly connected to a mount 10; characterized in that
by virtue of a bearing 40, the mount 10 is movable along a direction (A-Axis) which is substantially parallel with the first and/or second axis.

17. The drive assembly of claim 16, wherein the mount 10 comprises a portion of a torque-sharing system.

18. The drive assembly of claim 17, wherein the mount 10 comprises at least one link 16, at least one hinge 18, and at least one upper 12 or lower 14 arm.

19. The drive assembly of claim 18, wherein the mount 10 comprises one or more locking members 60 which are configured to prevent the at least one link 16 from articulating with the at least one upper 12 or lower 14 arm in a maintenance configuration.

20. The drive assembly of claim 19, wherein the mount 10 comprises at least two links 16, at least four hinges 18, an upper arm 12, and a lower arm 14.

21. The drive assembly of claim 20, further comprising a lower base 70.

22. The drive assembly of claim 21, wherein the bearing 40 is provided between the upper base 30 and the lower base 70.

23. The drive assembly of claim 22, wherein the bearing 40 is a linear or planar bearing oriented for permitting horizontal movement of the mount 10 in at least said direction (A-Axis) which is substantially parallel with the first and/or second axis.

24. The drive assembly of claim 23, further comprising at least one horizontal actuator 34 which is configured to move the mount 10 along the direction (A-Axis) which is substantially parallel with the first and/or second axis.

25. The drive assembly of claim 24, further comprising at least one vertical actuator 36 which is configured to move the upper base 30 with respect to the lower base 70 along a direction (B-Axis) which is substantially perpendicular to the first and/or second axis.

26. The drive assembly of claim 25, further comprising a drive support frame 80 provided to the upper base 30, wherein the drive support frame 80 comprises at least one vertical support member 86, an upper contact portion 82, and a number of jacks 84 therebetween, wherein the drive support frame 80 is configured to support the first drive 50 and/or the second drive 50 in a maintenance configuration.

27. The drive assembly of claim 26, further comprising an adjustable member 90 provided between the lower arm 14 and the upper base 30.

28. The drive assembly according to claim 16, wherein the one or more locking members 60 comprises a wedge member 62 held between a cradle 64, and the lower arm 14.

29. The drive assembly according to claim 28, wherein the one or more locking members 60 further comprises a wedge install/extract plate 63 operably connected to the wedge member 62.

30. The drive assembly according to claim 29, wherein the one or more locking members 60 further comprises two side support plates 61.

31. A method of removing a drive assembly for a comminution device, the comminution device comprising a first cylindrical roll having a first axis; a second cylindrical roll having a second axis; wherein the first axis being substantially parallel with the second axis to form a nip between the first cylindrical roll and the second cylindrical roll during operation of the comminution device; the method comprising:
simultaneously moving a drive assembly 1 away from the first cylindrical roll and the second cylindrical roll, in a direction (A-Axis) which is substantially parallel with the first and/or second axis;
wherein the drive assembly 1 comprises a first drive 50 operatively connectable to the first cylindrical roll and rigidly connected to a mount 10, and a second drive 50 operatively connectable to the second cylindrical roll and rigidly connected to the mount 10.

32. The method of claim 31, further comprising the step of attaching an adjustable member 90 between a lower arm 14 of the mount 10 and an upper base 30 supporting the mount 10; the adjustable member 90 being connected to an upper base adjustable member attachment point 92 provided to the upper base 30; the adjustable member 90 further being connected to a lower arm adjustable member attachment point 94 provided to the lower arm 14.

33. The method of claim 31, further comprising the step of raising an upper contact portion 82 of a drive support frame 80, and contacting a portion of the first drive 50 and/or the second drive 50 with the upper contact portion 82.

34. The method of claim 33, wherein the step of raising an upper contact portion 82 of a drive support frame 80 comprises engaging a number of jacks 84 provided between a vertical support member 86 and the upper contact portion 82.

35. The method of claim 31, wherein the step of contacting a portion of the first drive 50 and/or the second drive 50 with the upper contact portion 82 comprises contacting a top of the upper contact portion 82 of the drive support frame 80 with a rear flange 53 provided to the first and/or second drive 50.

36. The method of claim 31, further comprising the step of uncoupling a roll mount 52 of the first and/or second drive 50 from a drive coupling 51 of its respective first and/or second cylindrical roll.

37. The method of claim 31, further comprising the step of raising the upper base 30 using a vertical actuator 36, and contacting a portion of the upper base 30 with the lower arm 14 or a flange portion 24 of the lower arm 14.

38. The method of claim 37, further comprising the step of actuating a horizontal actuator 34 to move the upper base 30 relative to a lower base 70, in the direction (A-Axis) which is substantially parallel with the first and/or second axis, via a bearing 40 provided between the upper base 30 and the lower base 70.

39. The method of claim 38, further comprising the step of securing the horizontal actuator 34 to an actuator mount 32 located on the upper base 30 or the lower base 70, prior to said step of actuating.
